(19) United States
(12) Patent Application Publication
(10) Pub. No.: US 2017/0361751 A1
(43) Pub. Date: Dec. 21, 2017

(54) Wood chipper and a dump box that contains a unique dump door arrangement, as well as various dumping options, are integrated onto a utility type truck

(71) Applicants: Frank X. Quinn, Yorba Linda, CA (US); Kim M. Quinn, Yorba Linda, CA (US)

(72) Inventors: Frank X. Quinn, Yorba Linda, CA (US); Kim M. Quinn, Yorba Linda, CA (US)

(21) Appl. No.: 15/622,426

(22) Filed: Jun. 14, 2017

Related U.S. Application Data
(60) Provisional application No. 62/352,563, filed on Jun. 21, 2016.

(51) Int. Cl. B60P 1/28; B27L 11/02; B60P 1/16; B60P 3/00

(52) U.S. Cl. CPC B60P 1/283; B60P 3/00; B27L 11/02; B60P 1/16

(57) ABSTRACT

The present invention consists of a powered wood chipper mounted directly or indirectly to the frame of a utility type truck, thus eliminating the need for a separate trailer to carry said wood chipper to job sites. Said invention may also include a dump box, mounted directly or indirectly to the frame of the utility type truck, and whereby said dump box may be a sideways tilting assembly or may have a fixed position and incorporate a slanted or tilting floor assembly. Said dump box may also include a unique horizontal dump door arrangement with both an upper and lower doors. Presence of said lower dump door allows the dump box to discharge its load at a distance from the utility type vehicle. Said dump box may also feature slanted side or top surfaces, which may allow for greater visibility from the cab of the utility type vehicle and/or greater aerodynamics. These slanted side or top surfaces also allow the overall vehicle to have a narrower or lower profile and a lower center of gravity, leading to improved handling and safety for the work crew.

### CROSS REFERENCE

The present application is related to provisional application No. 62/352,563 filed Jun. 21, 2016, the disclosure of which is hereby incorporated by reference.

### PRIOR ART CITED

| Country | Patent | Title |
|---|---|---|
| US | 3,817,459 | Chute spreader bin collect |
| US | 4,338,985 | Chip storage bin |
| US | 4,633,776 | Compacting bin |
| US | 3,817,459 | Device and process for reclaiming used |
| | | wood |
| US | 4,338,985 | Tree and brushwood harvester |
| US | 4,633,776 | Branch compactor |
| US | 6,206,477 B1 | Yard Waste Handling Apparatus |
| US | 9,061,287 B1 | Chipper & Dump Box on Trailer |
| Canada | CA1163174A | Tree and brushwood harvester |
| Canada | CA1176543A | Tree and brushwood harvester |

### FIELD OF INVENTION

The invention relates to maintenance equipment used in trimming and removal of discarded tree and brush matter in a field location.

### PROBLEM STATEMENT

The need to transport a wood chipper unit to a job site on a separate trailer creates many problems which can be solved by the present invention. These problems include the cost and maintenance of the trailer itself, increased labor costs due to the physical handling of the trailer and safety issues related to the towing activity and field use of the trailer.

### BACKGROUND

Vegetation and in particular trees, coexist with modern infrastructure throughout the world. In the pursuit of this coexistence, it often becomes necessary to trim, prune or remove this vegetation in order to eliminate interference with the infrastructure surrounding said vegetation. When it becomes necessary to trim, prune or remove said vegetation, it is common practice to move what is commonly referred to as wood chipping equipment to the job site and to perform an operation on-site to chip the trimmed wood and vegetation debris into smaller fragments that can more easily be transported and disposed of. This chipping process reduces bulky branches and debris into a much smaller form factor, and allows the resultant chips to be more tightly packed in a storage container, reducing storage and transportation effort and costs.

Prior to this invention, wood chipping equipment brought to the job site has been mounted on an independent trailer assembly, incorporating its own frame, axles and wheels. The trailer requires being towed behind a utility type truck in order to reach the job site. In some cases, the trailer itself may contain a storage container structure, commonly referred to as a “dump box”. In other cases, the utility type truck towing the trailer may be equipped with a dump box. In either case, the dump box is used to store the chipped remains of the trees and vegetation that have been trimmed, pruned or removed at the job site. The wood chipping equipment that is mounted on the trailer contains a chute assembly attached to the wood chipping equipment that is used to direct the flow of the chipped remains from the chipping equipment to the dump box through an opening in the wall of the dump box. It should be noted that when the dump box is mounted on the utility type truck and the chipper equipment is mounted on the towed trailer, it is often necessary for the job attendant to reposition the trailer from the tow vehicle and reposition it in order to insure consistency in the level of the chipped remains in the dump box in order to maintain proper balance of the load.

The dump box is typically enclosed on all sides and contains top, bottom and side surfaces. Each of these surfaces may contain openings used for various procedures and purposes and the surfaces may be solid, or may use a soft tarp type material for covering the surface. These surfaces are provided to ensure that the chipped remains do not blow out of the dump box when it is in motion and to facilitate the emptying of the contents of the dump box.

Prior art teaches that the dump box may contain on one side a hinge assembly that sits between the dump box and the frame of the dump box and the utility type truck or the trailer it is mounted on. The dump box can be emptied of its contents by using the hinge assembly to tip the dump box at various, controlled angles to one side or the other of the utility type truck or trailer that it is mounted on. Thus the contents of the dump box can be dispersed to the passenger or drivers side of the utility type truck or the trailer, depending on the design of the dump box. This hinged tilting motion is provided by hydraulic equipment mounted under the dump box and controlled by the job attendant. In some cases when the dump box is mounted on the utility type truck, it may be tilted to the rear of the truck to unload its contents but it should be noted that when this arrangement is used, it becomes necessary for the job attendant to unhitch the trailer with the chipping equipment in order to keep the trailer clear of the debris being unloaded from the dump box. This is another example of the inefficiency of trailer mounted chipping equipment as it adds time and effort to the work of the job attendant.

These maintenance type operations are performed on both public and private lands. Both government agencies and private companies/individuals responsible for this effort may maintain their own equipment and labor for providing the service. In other cases, they may subcontract the work to outside firms or individuals who maintain their own equipment and crews and perform the desired work for the agency. Time and cost are major contributors to the outcome of this decision and thus, the time and cost advantages of this invention can greatly influence the outcome of these decisions.

Advantages enjoyed by the application of this invention include but are not limited to:
Lower cost of the equipment configuration, as the cost of the separate trailer is eliminated from the cost of the solution.
Eliminates the need to service the trailer, including routine maintenance and other items such as tires.
Eliminates the need and expense for separate state or local licensing or permits required on the trailer unit.
In most locations, vehicles towing a trailer are restricted to a lower speed limit and thus the travel time between job sites is reduced as the utility type truck, without a trailer, is not subject to these lower speed limits.
Labor costs are reduced because there is no need for the work crew to attach the trailer to the utility type truck including the need to attach the hitch from the tongue of the trailer to the hitch receiver on the utility type truck and to attach/detach additional elements such as safety chains, electrical connections and brake lines.
Labor costs in the field are also reduced as the trailer must often be detached from the utility type truck to allow for the contents of the dump box to be emptied.
The unique design of the dump box door allows the contents of the dump box to be emptied as a distance from the utility type truck to which the dump box is mounted, thus saving labor typically required to manually move the debris away from the vehicle.
The unique design of the dump box itself allows for greater visibility in their side view mirrors for the driver of the utility type truck.
The unique design of the dump box itself may allow for a more aerodynamic design of the dump box which can reduce wind resistance and increase fuel economy.
Because towed trailers often operate in a blind spot to the driver of the utility type trailer, they are often very difficult to back up, which can often lead to collisions with other vehicles or objects.
Because the wood chipper equipment is integrated onto the utility type vehicle, there is no need for additional insurance to be maintained on the separate trailer unit.
Vehicles with a combined gross weight of more than 26,000 pounds require that the driver have a commercial driver's license. Because the weight of the trailer is additive to that of the utility type truck, the weight of the trailer added to the gross weight calculation can require a driver with said commercial driver's license, thus increasing the necessary qualifications for the driver, and perhaps the labor cost.
When the wood chipper is mounted on the utility type truck it can be configured to share a fuel supply with the vehicle it is mounted on, whereby a trailer mounted wood chipper requires its own gas or diesel fuel supply which can create additional labor expense in maintaining.
The dump box defined by this invention can include a man type door or opening on the opposite side of the dump box from the dump door itself.
The sideways tilting of the dump box when mounted on the trailer can cause an unsafe situation as the weight of the contents of the dump boxes can approach 5.000 LBS and the shifting of the load during sideways tilting in the dumping operation can cause the trailer to become unstable and prone to tipping over when the operation is performed with the trailer disconnected from the utility type truck.
It is often necessary when the dump box is mounted on the utility type truck for the job attendant to reposition the trailer from the tow vehicle and reposition it in order to insure consistency in the level of the chipped remains in the dump box in order to maintain proper balance of the load.

### SUMMARY OF THE INVENTION

With regard to the preferred embodiment of this invention, the disclosed integration of the wood chipper onto the utility type truck eliminates the disadvantages associated by the requirement to tow a separate trailer on which the wood chipper is mounted and associated with prior art techniques and apparatus.

In a preferred embodiment of this invention, the wood chipper integration onto the utility type truck eliminates the need to tow a separate trailer behind said truck in order to get the wood chipper to the jobsite. The wood chipper is mounted to the back of the frame of the utility type truck and the dump box is mounted between the cab of the truck and the wood chipper. The dump box has an opening in the rear surface that allows the chute assembly mounted on the wood chipper to exhaust its chipped output into the dump box.

In another preferred embodiment of this invention, the dump box is pivotally mounted on the utility type truck and allows for sideways tilting between and upright normal position and a tilted unloading position, or any angles between the defined limits. This sideways tilting operation is enabled by hydraulic rams mounted below the dump box and this tilting operation is controlled remotely by the job attendant.

In another preferred embodiment of this invention, one side surface of the dump box defined as having a dump door may be located on either the driver or passenger side of the utility type truck. This is the surface that moves closer to the ground during the sideways tilting operation of the dump box. In this embodiment, the dumping door surface is not a single door, but rather a two door arrangement located in a horizontal manner from the front of the dump box to the rear of the dump box. Thus these two doors will be referred to as the “Upper Dump Door” and “Lower Dump Door” for purposes of this disclosure.

The upper horizontal dump door occupies some portion of the total vertical height of the dump door opening and is hinged at the top of the door opening and is not itself latched to the front and rear surface of the dump box. The lower horizontal dump door occupies the balance of the dump door opening vertical height and is hinged at the bottom of the door opening. Mechanical latching mechanisms are used on the lower dump door to secure it to the dump box when in the full upright position and during transport. The lower dump door also includes a raised edge on its upper surface that overlaps the bottom edge of the upper door and is used to hold the upper door tight against the edges of the dump box during transport.

The upper dump door is not mechanically controlled. During the sideways tilting operation used in emptying the content of the dump box, natural gravity is used to cause the upper dump door to move away from the unhinged edges of the dump box at an angle determined by gravity and the current tilt angle.

The lower dump door contains mechanical apparatus at one or both ends of the lower dump door which only allows said lower door to move down to a defined angle during the sideways tilting operation. While that angle can be variable, the lower dump door is typically allowed to open only to the angle whereby it is relatively level with the floor surface of the dump box itself, even when the dump box itself is in the tilted position. This limitation of the allowable opening angle enables the lower dump door to be used as a physical extension of the dump box floor, which allows the contents being dumped from the dump box to be physically deposited away from the utility type truck. This eliminates the need to manually clear the debris away from the utility type truck.

In another embodiment of the dump box defined by this disclosure its design allows the dump box to have a variable width, whereby the lower width of the dump box is the widest and the width diminishes higher up on the dump box. This feature allows for greater visibility by the driver of the utility type truck and may also increase the aerodynamics of the dump box. In addition, the larger lower width of the dump box promotes a lower center of gravity and may also provide a lower height profile to the dump box.

In another embodiment of the dump box defined by this disclosure its design allows the dump box to have a sloping roof panel whereby either the front or back panel of the dump box is lower than the opposite panel which can create a lower center of gravity for the vehicle and may also provide a lower profile as well as a more aerodynamic profile, reducing wind resistance and increasing fuel economy.

In another embodiment of this invention, the dump box may contain a side door in the dump box side surface opposite the side of the dump box containing the upper and lower dump doors. This door may also cover a closet type arrangement existing inside the dump box and used for storage purposes. This side door may also incorporate a ramp type arrangement for loading and unloading of equipment into this closet type area.

In another embodiment of this invention, the dump box may contain an open top surface, covered only by a removable soft cover, which allows larger waste items to be inserted into the dump box.

In another embodiment of this invention, the floor panel of the dump box may be fixed within the dump box but slanted from a higher dimension where attached to the side panel opposite the panel including the dump door and a lower dimension where attached to the side panel incorporating one or more doors used for dumping the contents of the dump box. This fixed slanted floor panel arrangement enhances the dumping of the dump box contents by using downward gravity achieved by the slanted floor assembly to make it easier for job attendants to empty the contents. The dump box, when incorporating this fixed slanted floor assembly may also include another secondary fixed floor assembly that is flat in height when measured between the two side panels of the dump box and is mounted under the fixed slanted floor assembly. This secondary flat floor assembly can provide a floor surface for use of the space between itself and the slanted fixed floor assembly that can be used for storage of equipment and said storage space may be accessible from a door panel mounted in the side panel of the dump box opposite the dumping doors.

In another embodiment of this invention, the dump box may have a pivoting adjustable floor surface panel and at least one piston assembly mounted directly or indirectly between the bottom surface of said adjustable floor surface panel and the frame of a utility type truck, such that said piston assembly can raise the side of the floor surface panel on the opposite side of said side panel containing one or more dumping doors, positioning the adjustable floor surface panel at a downward slanted angle toward the side panel containing said dumping door and allowing the contents of said dump box to be discharged out said dumping door mounted in said side panel of said dump box.

These and other embodiments of this invention will become apparent in the following description of the present invention.

### Definitions

Utility Type Truck: A self-propelled vehicle that is configured for use in work type environments and may have pertinent equipment mounted directly to the vehicle.
Wood Chipper: A powered device that accepts tree limbs or other vegetation and grinds it up into small pieces called chips.
Dump Box: A storage container used to store chips and other foliage and containing a dump door that allows the contents to be emptied.
Chute Assembly: An attachment to a wood chipper that directs the chipped matter produced by the wood chipper to the dump box.
Input Assembly: An attachment to a wood chipper that accepts the input of tree or vegetation material into the wood chipper.
Job Attendant: One or more members of the work crew assigned to the effort.
Tilting Dump Box: A dump box assembly mounted on a utility type truck that uses a piston assembly to tilt the dump box along a horizontal axis in order to allow gravity to discharge the contents of said dump box.

### SHORT DESCRIPTION OF THE DRAWINGS

FIG. 1 is a side view of the invention showing the truck with a chipper and dump box.

FIG. 2 is the back view of the invention showing the back of the truck with a chipper and dump box.

FIG. 3 is the side view of the dump doors on one side of the dump box.

FIG. 4A is a detail view of the latching configuration of the top and bottom dump doors where the latching mechanism is mounted on the inside bottom portion of the upper dump door.

FIG. 4B is a detail view of the latching configuration of the top and bottom dump doors where said latching mechanism is mounted on the outside top portion of the lower dump door.

FIG. 5 is a side view of the side of the box opposite the dump doors and showing an access door to the interior of the dump box.

FIG. 6 is a cutaway view of the back end of the dump box showing the movable floor panel allowing dumping without tilting the box to empty the contents.

FIG. 7 is a cutaway view of the back end of the dump box showing the movable floor as an incline with a hydraulic cylinder raising the movable floor, permitting dumping without tilting the dump box.

FIG. 8 is a back view of the invention on the back of a utility truck where the dump box is tilted by a hydraulic ram and the dump doors open.

FIG. 9 is a back view of the invention showing the back of the truck with a chipper and a tapered dump box.

FIG. 10A is a side view of the outside of the dump box showing hydraulic cylinders controlling a lower dump door.

FIG. 10B is a back view of the outside of the dump box showing hydraulic cylinder and the lower dump door in a closed position.

FIG. 10C is a back view of the outside of the dump box showing hydraulic cylinder and the lower dump door in an open position.

FIG. 11A is a cutaway view of the end of the dump box showing the floor as an incline allowing dumping without tilting the box to empty the contents.

FIG. 11B is a cutaway view of the dump of the end of the dump box showing the floor as an incline with a door giving access to the hollow portion under the floor providing tool storage.

### DETAILED DESCRIPTION OF THE DRAWINGS

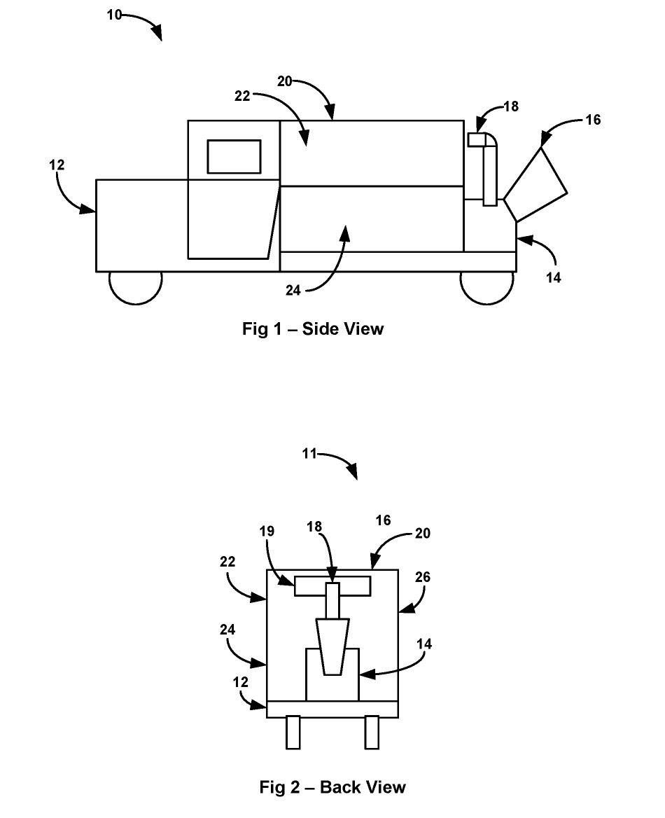

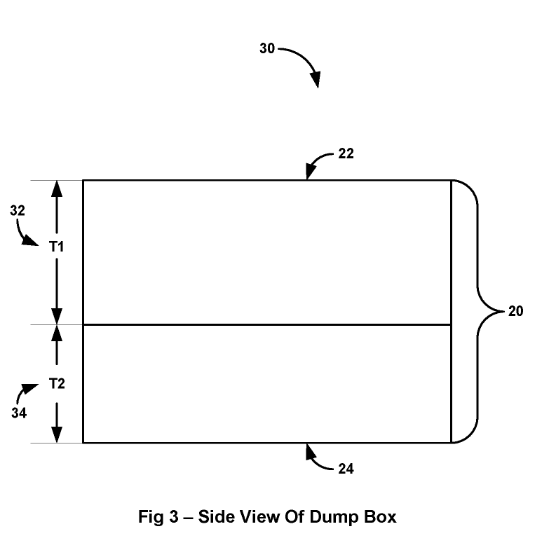

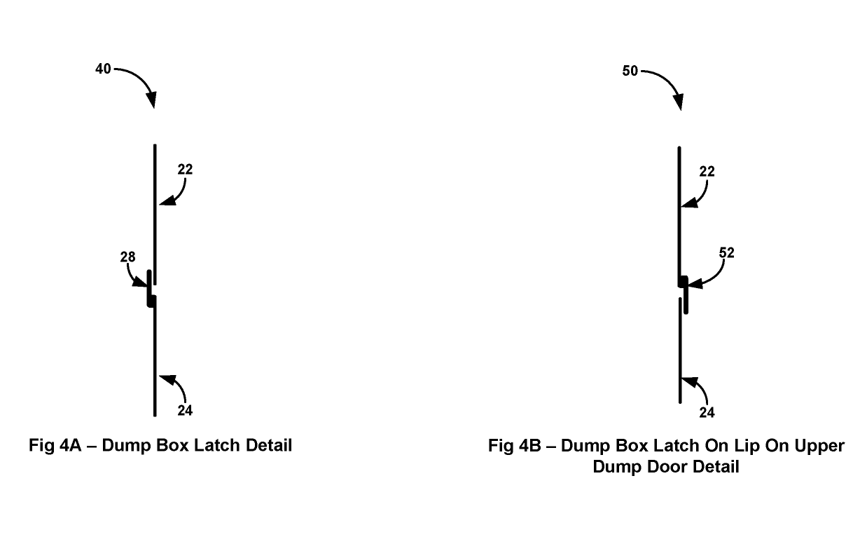

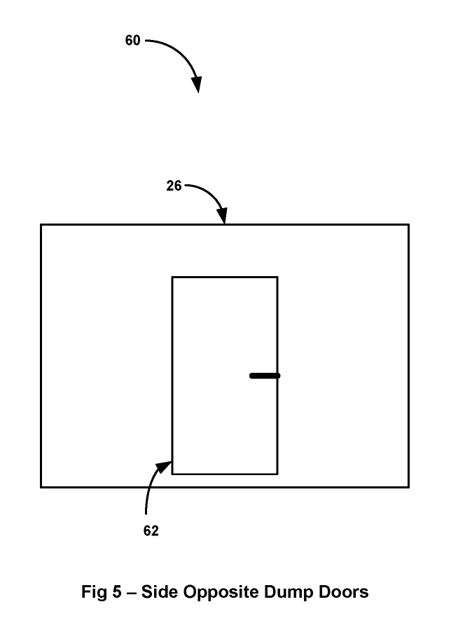

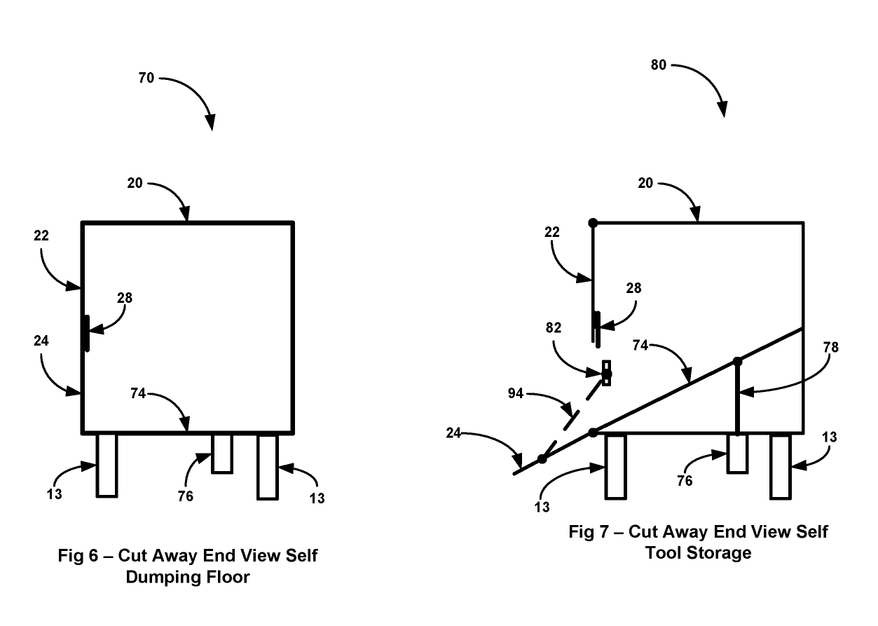

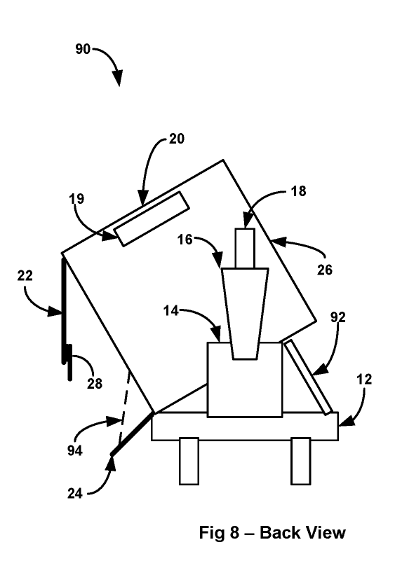

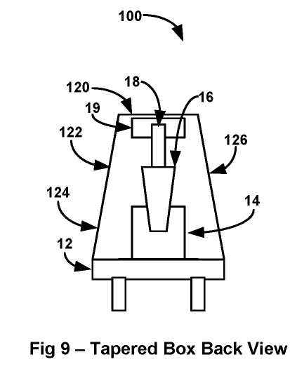

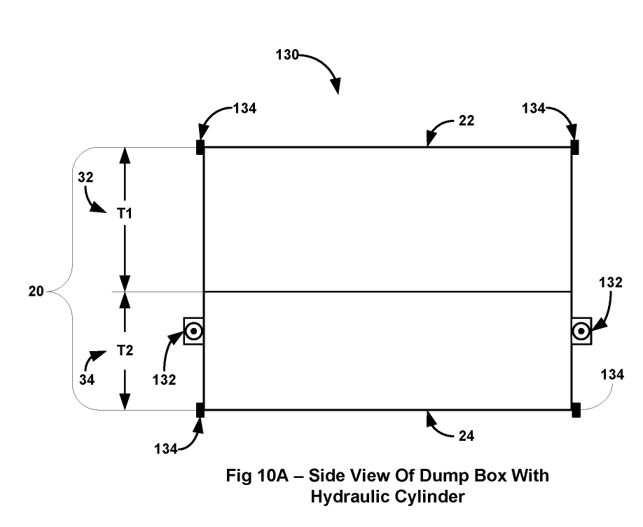

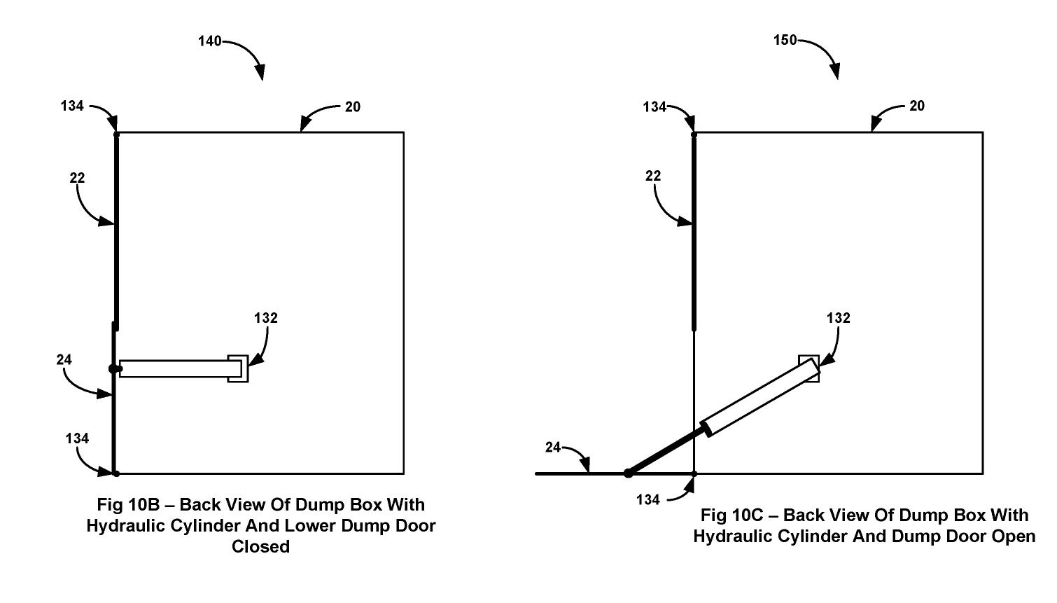

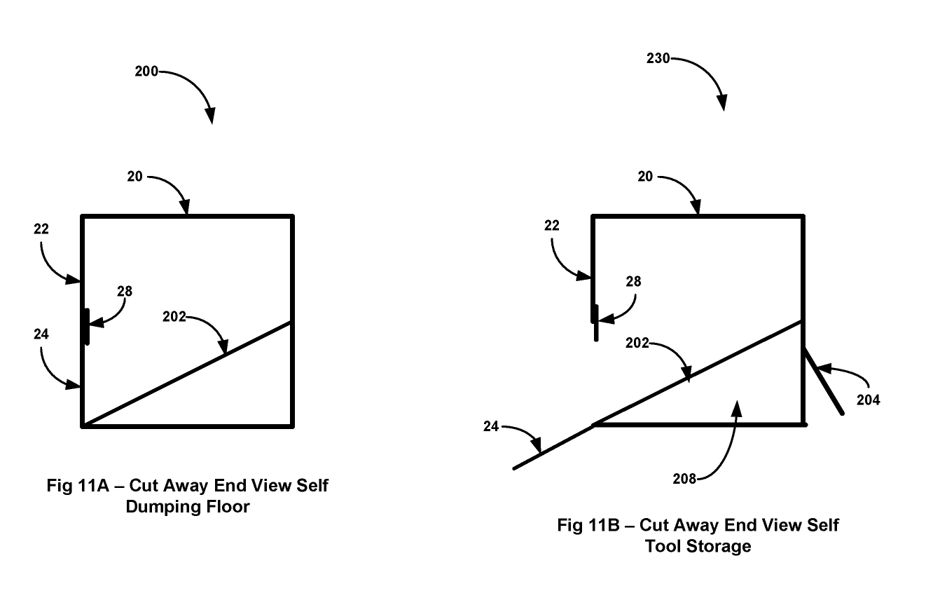

The following descriptions describe the various embodiments of the invention where like objects are numbered the same.
Now referencing FIG. 1 where 10 depicts the invention mounted on a utility truck. In this depiction, utility truck 12 is shown with dump box 20 having an upper dump door 22 and a lower dump door 24. Chipper 14 is mounted at the aft end of dump box 20 with branch and leaf feeder horn 16 and discharge assembly 18 which blows chipped debris into dump box 20.
Now referencing FIG. 2 where 11 depicts the back end view of the invention mounted on utility truck 12. In this depiction dump box 20 is shown having an upper dump door 22 and a lower dump door 24. Chipper 14 is mounted on the end of utility truck 14 with branch and leaf feeder horn 16 and discharge assembly 18 which blows chipped debris into dump box opening 19 of dump box 20.
Now referencing FIG. 3 where 30 depicts a side view of upper dump door 22 and lower dump door 24. In this depiction, T1 32 and T2 34 show the relative vertical height of each dump door. The size of upper dump door 22 is shown as T1 32 and the size of lower dump door 24 is shown as T2 34. The relative size of the upper dump door 22 is, at a minimum, 51% of the overall height of the combined dump doors and the relative size of the lower dump door 24 is, at a minimum, 49% of the overall height of the combined dump doors.
Now referencing FIG. 4A where 40 depicts an end view detail of upper dump door 22 and lower dump door 24 where latch 28 is attached to inside lower edge of upper dump door 22. When upper dump door 22 closed and lower dump door 24 is closed and locked into the closed position, latch 28, affixed to upper dump door 22, will prevent upper dump door 22 from opening. Latch 28 keeps upper dump door 22 locked into position without any other locking mechanism.
Now referencing FIG. 4B where 40 depicts an end view detail of upper dump door 22 and lower dump door 24 where latch 52 is attached to the outside lower edge of lower dump door 24. When upper dump door 22 closed and lower dump door 24 is closed and locked into the closed position, latch 52, affixed to the outside upper edge of dump door 24, will prevent upper dump door 22 from opening. Latch 52 keeps upper dump door 22 locked into position without any other locking mechanism.
Now referencing FIG. 5 where 60 depicts a side view of dump box 20. Dump box 20 side 26 is the side opposite upper dump door 22 and lower dump door 24. In this depiction, access door 62 provides an operator with access to the interior of dump box 20 without the operator having to climb over the side of dump box 20 to gain access.
Now referencing FIG. 6 where 70 depicts a cut away view from the back of dump box 20. In this view upper dump door 22 and lower dump door are shown with upper dump door latch 28 affixed to upper dump door 22. A second floor portion 74 is shown in its retracted position flat against the bottom of dump box 20. Dump box 20 is shown setting on utility truck 12 chassis rails 13. In this depiction, hydraulic cylinder 76 is shown attached to the bottom of dump box 20 with its ram 78 retracted inside of hydraulic cylinder 76.
Now referencing FIG. 7 where 80 depicts a cut away view from the back of dump box 20. In this view upper dump door 22 and lower dump door are shown with upper dump door latch 28. A second floor portion 74 is shown at an angle where second floor portion 74 slopes has been elevated by hydraulic cylinder 76 and ram 78. Lower dump door 24 is shown open to a position where it is in line with second floor portion 74 and held in place by mechanism 94 which is attached to either the inside or outside of the back panel of dump box 20. Mechanism 94 may be a chain, or a solid jointed arm, or a solid sliding arm, or a hydraulic cylinder (shown in FIGS. 10A, 10B, and 10C), or any other such holding mechanism. The mechanisms depicted in FIG. 6 and FIG. 7 allows the contents of dump box 20 to be emptied without tilting dump box 20.
Now referencing FIG. 8 where 90 depicts dump box 20 in an unloading position. In this depiction, hydraulic ram 92 has tilted dump box 20 and lower dump door 24 has been released and held in position by mechanism 94 and is in position to deposit the debris contained in dump box 20 away from the undercarriage of utility truck 12. Mechanism 94 may be a chain, or a solid jointed arm, or a solid sliding arm, or a hydraulic cylinder (shown in FIGS. 10A, 10B, and 10C), or any other such holding mechanism. Upper dump door 22 is shown hanging down in a vertical manner from the force of gravity after lower dump door 24 is released and which latch 28 or latch 52 releases upper dump door latch 28 or lower dump door latch 52. Also shown is dump box opening 19.
Now referencing FIG. 9 where 11 depicts the back end view of the invention mounted on utility truck 12 where dump box 120 is tapered from the top to the bottom to allow greater visibility for the driver of utility vehicle 12 and dump box 120 allowing the driver greater visibility of the side of dump box 120. In this depiction dump box 120 is shown having an upper dump door 122 and a lower dump door 124. Chipper 14 is mounted on the end of utility truck 14 with branch and leaf feeder horn 16 and discharge assembly 18 which blows chipped debris into dump box 120 through dump box opening 19.
Now referencing FIG. 10A where 130 depicts a side view of upper dump door 22 and lower dump door 24. In this depiction, hinge assembly 134 shown at the top corners of upper dump door 22 and at the bottom corners of lower dump door 24. These hinge assemblies allow upper dump door 22 to swing outward when dump box 20 is tilted and allow lower dump door 24 to be pushed to an open position (FIG. 10C) when hydraulic cylinder 132 is activated and extended. In the present figure, hydraulic cylinder 132 is shown in a retracted position and lower dump door 24 is shown as closed.
Now referencing FIG. 10B where 140 depicts a back view of dump box 20. In this depiction, upper dump door 22 and lower dump door 24 are shown in closed positions and hinge assemblies 134 are shown at the top corners of upper dump door 22 and at the bottom corners of lower dump door 24. These hinge assemblies allow upper dump door 22 to swing outward when dump box 20 (FIG. 8) is tilted and allow lower dump door 24 to be pushed to an open position (FIG. 10C) when hydraulic cylinder 132 is activated and extended. In the present figure, hydraulic cylinder 132 is shown in a retracted position and lower dump door 24 is shown as closed.
Now referencing FIG. 10C where 150 depicts a back view of dump box 20. In this depiction, upper dump door 22 is shown in an open position prior to dump box 20 being tilted to empty debris from inside dump box 20. Lower dump door 24 is shown in an open position. In the present figure, hydraulic cylinder 132 is shown in an extended position and lower dump door 24 is shown as open and level with the flow of dump box 20.
Now referencing FIG. 11A where 200 depicts a cut away view from the back of dump box 20. In this view upper dump door 22 and lower dump door 24 are shown with upper dump door latch 28 affixed to upper dump door 22. A second floor portion 202 is shown at an angle where the second floor portion 202 slopes down toward the bottom of lower dump door 24. This allows dump box 20 to be emptied without activating hydraulic ram 92 shown in FIG. 8. In this present depiction, once lower dump door 24 is opened, debris in dump box 20 will slide out of dump box 20 by the force of gravity.
Now referencing FIG. 11B where 230 depicts a cut away view from the back of dump box 20. In this view upper dump door 22 and lower dump door 24 are shown with upper dump door latch 28. A second floor portion 202 is shown at an angle where second floor portion 202 slopes down toward the bottom of lower dump door 24. In this depiction, tool storage door 204 provides access to a tool area portion that resides between the bottom of dump box 20 and second floor portion 202. Tool storage door 204 may be secured through the use of a locking handle or through the use of a pad lock device.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternatives which might be predictable to a person having ordinary skill in the art. For example, other sizes and thicknesses can be used.

Those of skill in the art would further appreciate that the various illustrative components, assemblies, and methods described in connection with the embodiments disclosed herein may be implemented in multiple ways. To clearly illustrate this interchangeability of components, assemblies, and methods, and steps have been described above generally in terms of their functionality. Skilled artisans may implement the described functionality in varying ways for each particular application, but such implementation decisions should not be interpreted as causing a departure from the scope of the exemplary embodiments.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

We claim the following:

1. An improved assembly for a truck with an integrated wood chipper and a dump box comprising:
a. a truck and a dump box comprising:
i. a frame composed of frame members on which are mounted:
1. an engine compartment, and
2. a driver's cab, and
3. a plurality of wheel assemblies, and
4. a wood chipper device, and
5. a dump box with a front wall and a rear wall and a left-side wall and a right-side wall;
b. said wood chipper device is mounted directly or indirectly to at least one of said frame members;
c. said dump box is positioned between said driver's cab of said truck and said wood chipper device;
d. said dump box is pivotally mounted to one of at least one of said frame members allowing said dump box to be tilted between an upright fill position and a sideways tilted dump position;
e. said dump box composed of a front wall, a rear wall, and opposite side walls with a dump door opening in at least one of said opposite side walls of said dump box;
f. said dump box having a solid or open top cover,
g. said dump box having an inlet opening in its rear wall allowing said wood chipper device to exhaust chipped output into said dump box;
h. said dump box having at least one piston assembly attached between said dump box and at least one of said frame members and is used for longitudinally pivoting said dump box between upright and tilted positions.

2. The truck of claim 1 whereby said dump box may include an access door type arrangement located in one or more side panels to provide entry to said dump box or for storage of equipment.

3. The truck of claim 1 wherein said truck has a longitudinal axis and said dump box can pivot about an axis parallel to the longitudinal axis of said frame members.

4. The truck of claim 1 whereby said wood chipper mounted directly or indirectly to at least one frame member of said truck includes an inlet chute in said rear-wall or said left-side wall or said right-side wall of said dump box.

5. The truck of claim 1 whereby said wood chipper mounted to a frame member of said truck includes a forward-facing outlet chute for discharging chipped material into said dump box through an opening in said rear-wall of said dump box.

6. A dump box assembly, mounted to a frame of a truck or to a towable trailer assembly comprising:
a) a side panel composed of a lower horizontal dumping door and an upper horizontal dumping door mounted directly or indirectly to a frame member of a truck or to a towable trailer assembly;
b) an opposing side panel;
c) a front wall panel and a rear wall panel;
d) a bottom panel and a top panel;
e) said bottom panel is tilted in a direction toward said lower horizontal dumping door and said upper horizontal dumping door to allow discharge of contents of said dump box assembly;
f) said dump box assembly incorporates a mechanical assembly mounted between the lower horizontal dumping door and one or more of the front wall and the rear wall of said mechanical assembly controls a predetermined distance said lower horizontal dumping door opens.

7. The dump box assembly of claim 6 whereby said lower horizontal dumping door is hinged adjacent to the bottom of said dump box assembly and when opened to the predetermined distance controlled by the mechanical assembly, is relatively flat or level with the bottom of said dump box assembly.

8. The dump box assembly of claim 6 whereby the upper horizontal dumping door is hinged adjacent to the top of said dump box assembly, so as to pivot about a horizontal axis.

9. The dump box assembly of claim 6 whereby the lower horizontal dumping door is hinged adjacent to the bottom of said dump box assembly to pivot about a horizontal axis when said dump box assembly is tilted toward the side panel where the upper horizontal dumping door and the lower horizontal dumping door are located.

10. The dump box assembly of claim 6 whereby opening of the upper horizontal dumping door and the lower horizontal dumping door are both gravity controlled during a tilting operation.

11. The dump box assembly of claim 6 whereby opening of the lower horizontally dumping door may be controlled while said dump box assembly is being tilted by one or more piston assemblies attached to said lower horizontal dumping door and to the front wall and the rear wall of said dump box assembly for moving said lower horizontal dumping door between a predetermined open position and a closed position.

12. The dump box assembly of claim 6 whereby either the upper horizontal dumping door or lower horizontal dumping door in the side panel of the dump box assembly has an overlapping mechanical lip used to overlap the other horizontal door to hold said overlapped door in a closed position during transport.

13. The dump box assembly of claim 6 whereby either a front wall or a back wall of said dump box assembly is shorter than the opposite panel of said dump box assembly, thus producing a slanted top surface from the front wall to the back wall or from the back wall to the front wall and thus a shorter height dimension when measured at one end of said dump box assembly and a taller height dimension when measured at the opposite end of said dump box assembly.

14. The dump box assembly of claim 6 whereby a fixed floor surface panel of said dump box assembly is slanted and angled between 2 side panels of said dump box assembly such that said fixed floor surface panel mounted on a side panel without a dumping door is mounted at a greater height dimension and angling downward to a lower height dimension at an intersection of said fixed floor surface panel and said side panel containing one or more dumping doors.

15. A dump box assembly whereby a pivoting adjustable floor surface panel and at least one piston assembly mounted directly or indirectly between said pivoting adjustable floor surface panel and a frame member of a truck such that said piston assembly can raise one side of said pivoting adjustable floor surface panel on the opposite side of said side panel containing one or more dumping doors thereby positioning the pivoting adjustable floor surface panel at a downward slanted angle toward the side panel containing said one or more dumping doors and allowing discharge of contents of said dump box assembly outside of said one or more dumping door mounted in said side panel of said dump box assembly.

16. The dump box assembly of claim 15 whereby said dump box assembly with a pivoting adjustable floor surface panel may be mounted directly or indirectly to a frame member of either said truck or a towed trailer.

17. The dump box assembly of claim 15 whereby said piston assembly mounted between said frame member of said truck may be manually operated, or may be operated hydraulically or operated electronically.

18. The dump box assembly of claim 15 whereby the pivoting adjustable floor surface panel is hinged at an intersection of said pivoting adjustable floor surface panel and said side panel containing one or more dumping doors.
